(19) United States
(12) Patent Application Publication
(10) Pub. No.: US 2024/0412227 A1
(43) Pub. Date: Dec. 12, 2024

(54) PUNCH IN AND OUT SYSTEM WITH FUNCTION OF AUTOMATICALLY MEASURING CARBON FOOTPRINT FROM EMPLOYEE COMMUTES

(71) Applicants: KENG-CHEN SHEU, Taichung City (TW); UniSmart Technology Co., Ltd., Taichung City (TW)

(72) Inventors: HSIANG-CHING CHANG, Keelung City (TW); KENG-CHEN SHEU, Taichung City (TW)

(21) Appl. No.: 18/678,034

(22) Filed: May 30, 2024

(30) Foreign Application Priority Data
Jun. 12, 2023 (TW) 112121780

(51) Int. Cl. G06Q 30/018; G06Q 10/105

(52) U.S. Cl. CPC G06Q 30/018; G06Q 10/105

(57) ABSTRACT

A punch in and out system with a function of automatically measuring carbon footprint from employee commutes includes a comparison unit, a cloud database, an input unit, a computation unit and an output unit, the comparison unit includes a transportation carbon emission comparison module and an employee commuting distance data comparison module, the cloud database is provided with an editing device for editing and storing a transportation carbon emission database and an employee commuting distance database, the input unit includes at least one punch in and out passage and a plurality of recognition devices, the computation unit carries out a computation according to the comparison results of the transportation carbon emission comparison module and the employee commuting distance data comparison module, the output unit is provided for outputting the computation result of the computation unit to generate a report.

### BACKGROUND

### Technical Field

The present disclosure relates to a punch in and out system, more particularly relates to a punch in and out system with a function of automatically measuring carbon footprint from employee commutes and its process.

### Description of Related Art

Generally, a company manages the attendance of its employees by using a punch clock or a proximity card to punch in and out. However, the current punch in and out method allows a company to impersonate another person by obtaining their punch card or proximity card, which makes it impossible for the company to effectively manage the absence and attendance of its employees.

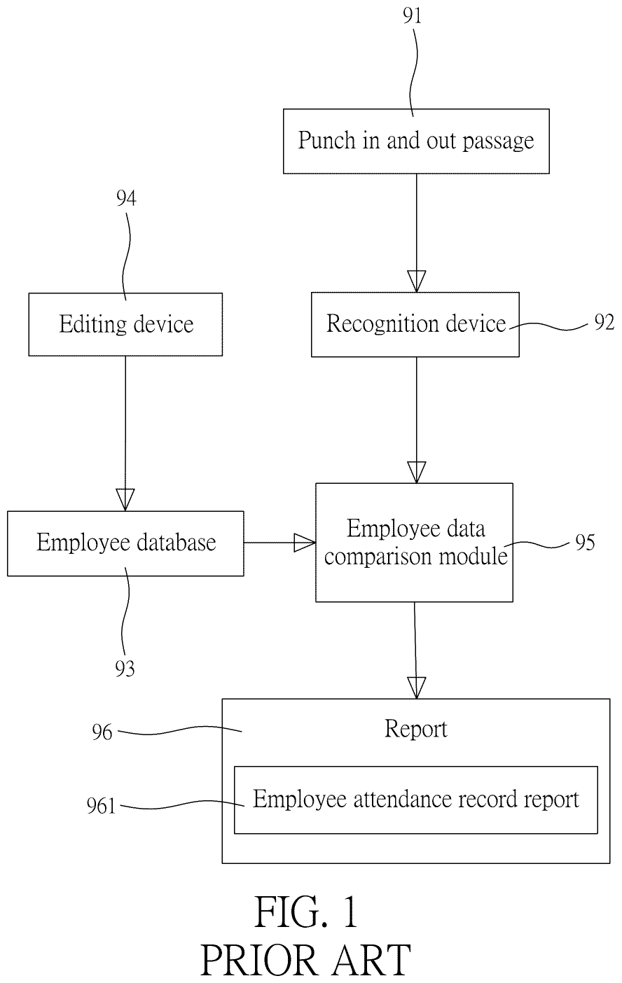

Therefore, there is a process for a conventional punch in and out system as shown in FIG. 1, and the system includes a punch in and out passage 91, a recognition device 92, an employee database 93, an editing device 94 and an employee data comparison module 95, wherein the punch in and out passage 91 is provided for employees to punch in when entering the company for work or to punch out when leaving the company after work, the recognition device 92 is located in the punch in and out passage 91 and provided for identifying the employees passing through the punch in and out passage 91, the employee database 93 is provided for storing employee data, the editing device 94 is connected to the employee database 93 and provided for editing and inputting new employee, current employee or ex-employee data into the employee database 93, the employee data comparison module 95 is connected to the recognition device 92 and the employee database 93 for comparing the identity of the employee identified by the recognition device 92 with the employee data stored in the employee database 93 to generate a report 96 which is an employee attendance record report 961.

The above-mentioned conventional process of the punch in and out system can enhance the efficiency of a company's personnel management by utilizing the automatic punch in and out operation and the generation of the employee attendance record report 961. However, the following issue has not been taken into account. Due to the worsening of the global warming problem nowadays, the earth's climate and environmental changes will affect the survival of all kinds of creatures on the earth in the future, and the problem of global warming is closely related to the carbon emissions generated by human beings, countries around the world have been actively calling for the reduction of carbon emissions, and formulated various “Carbon Footprint Verification” methods.

The world's leading brands are demanding carbon neutrality in their supply chains, and the first step towards carbon neutrality is carbon footprint verification, which is a scientific methodology that meets international standards for calculating the carbon emissions of an enterprise/organization's operations across a wide range of activities. Although the carbon footprint verification report is only required to be disclosed once a year, it is important to keep an eye on the status of carbon emissions to ensure that we are on the right track to reduce carbon emissions. The further development of digital system tools of carbon footprint verification for carbon emission statistics will enable us to obtain more accurate, complete and transparent scientific data on greenhouse gas (GHG) emissions in a more efficient manner.

Three major emission scopes of carbon footprint verification refer to the three major scopes of GHG emissions based on their sources: Scope 1 refers to direct emissions from processes or facilities; Scope 2 refers to indirect emissions from purchased electricity, heat or steam; and Scope 3 refers to emissions from sources that are not owned or controlled by a company, such as emissions from leasing, outsourcing, commuting, etc.

Most companies focus on Scope 1 and Scope 2 GHG emissions in their annual carbon footprint verification, and many companies ignore Scope 3 GHG emissions, but many industries emit the most carbon in Scope 3. The more upstream and downstream supply chains in manufacturing and service industries, the more transportation; and the more commutes and business travels, the higher the GHG emissions in Scope 3.

Although the carbon emission coefficients of various transportation modes (per man-kilometer) can be easily found, traditional enterprise statistics on carbon emissions from employee commutes must be manually collected and then roughly calculated, which involves a cumbersome and time-consuming process, and there is no integrated punch in and punch out digital tool to carry out the measurement of carbon footprint verification from employee commutes, and the enterprise is unable to formulate encouragement and incentive programs to reduce carbon emissions, resulting in the ineffective implementation of the call for carbon reduction in employee commutes within the enterprise.

### SUMMARY

In view of the aforementioned deficiencies of the related art, it is a primary objective of the present disclosure to provide a punch in and out system with a function of automatically measuring carbon footprint from employee commutes to overcome the deficiencies. The punch in and out system includes: a comparison unit, including a transportation carbon emission comparison module and an employee commuting distance data comparison module; a cloud database, connected to the comparison unit and provided with an editing device for editing and storing a transportation carbon emission database and an employee commuting distance database, the transportation carbon emission database being connected to the transportation carbon emission comparison module, and the employee commuting distance database being connected to the employee commuting distance data comparison module; an input unit, connected to the comparison unit, and including at least one punch in and out passage and a plurality of recognition devices, the at least one punch in and out passage being provided for employees to enter the company for work or leave the company after work, the plurality of recognition devices being installed in the at least one punch in and out passage and provided for the recognition of employees by the corresponding recognition device selected by the employee according to the commuting transportation and to obtain the information of employee commuting transportation and employee commuting distance; a computation unit, connected to the comparison unit for computation according to the comparison results of the transportation carbon emission comparison module and the employee commuting distance data comparison module; and an output unit, connected to the computation unit, for outputting the computation result of the computation unit to generate a report. The process of the punch in and out system with a function of automatically measuring carbon footprint from employee commutes includes the steps of: (a) editing a transportation carbon emission value, wherein the editing device edits and saves various transportation carbon emission coefficients (per man-kilometer) to the transportation carbon emission database; (b) editing an employee commuting distance, wherein the editing device edits and saves the employee commuting distance data to the employee commuting distance database of a company; (c) performing a recognition step, wherein when an employee arrives at the company, the employee enters through a punch in and out passage and selects a corresponding recognition device for recognition, and the comparison unit obtains the information of the employee commuting transportation and employee commuting distance and simultaneously starts the transportation carbon emission comparison module and the employee commuting distance data comparison module to perform a comparison; and (d) performing a computation step, wherein a carbon emission report and an employee attendance record report are generated and provided for review automatically based on the compared transportation carbon emission value and the compared employee commuting distance.

The main purpose of the present disclosure is that in addition to the automatic punch in or punch out operation using recognition and the generation of attendance record reports for each employee to improve the company's personnel management efficiency, the present disclosure can also automatically calculate the carbon emissions produced by each commuting employee, replacing the traditional annual carbon footprint verification that relies on manual and tedious collection of data and rough estimates (such as number of employees in the department*number of working days*carbon emission data per kilometer of a specific vehicle*employee commuting distance), and thus the present disclosure is conducive to the effectiveness of a company which conducts the calculation of carbon footprint verification of commuting employees more accurately and improves efficiency and accuracy of carbon footprint verification.

### BRIEF DESCRIPTION OF THE DRA WINGS

FIG. 1 is a flow chart of a conventional punch in and out system;

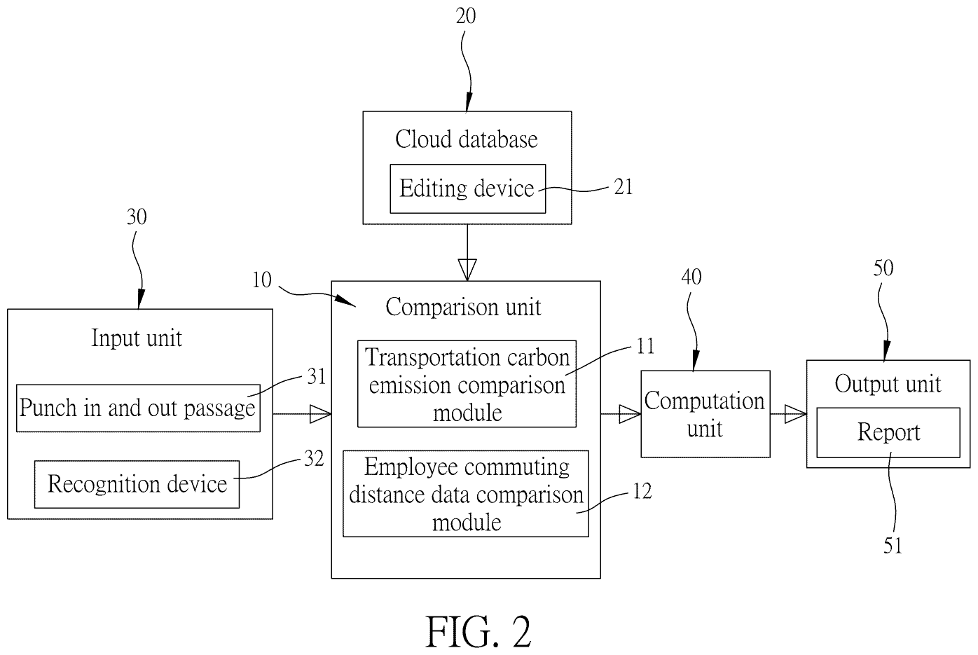

FIG. 2 is a schematic block diagram showing the structure of a punch in and out system of the present invention;

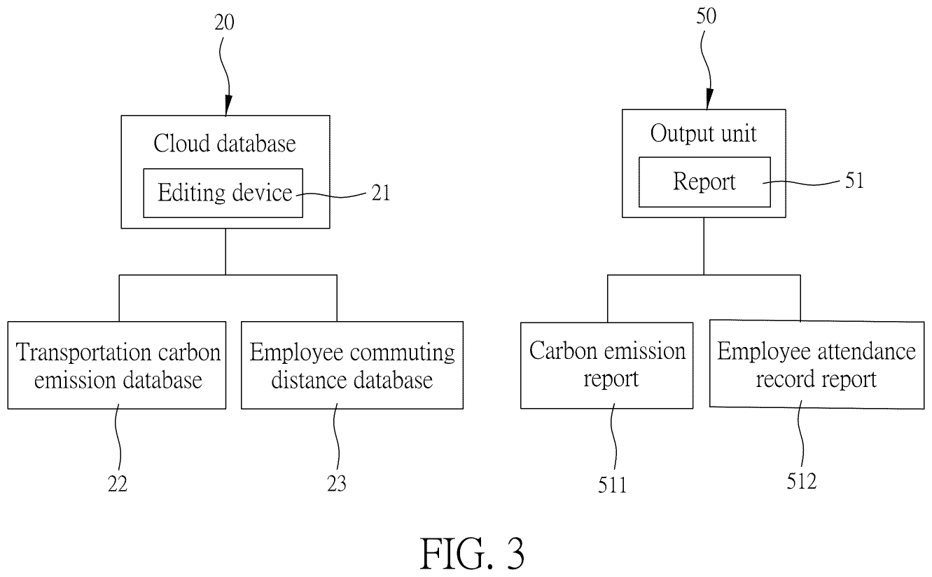

FIG. 3 shows the structures of a cloud database and an output unit of the present invention;

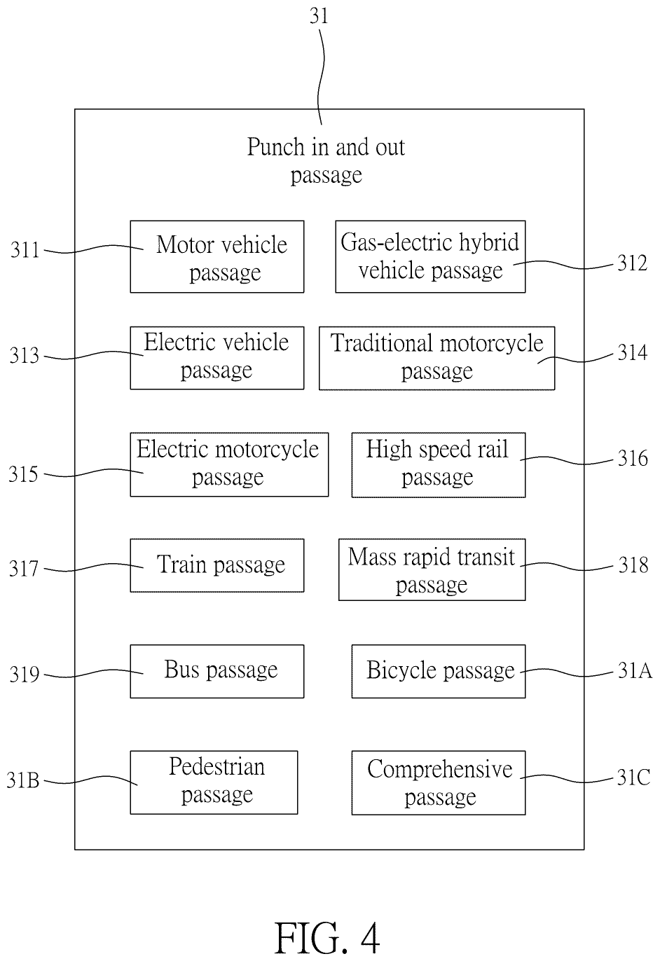

FIG. 4 is a schematic diagram showing a punch in and out passage of the present invention;

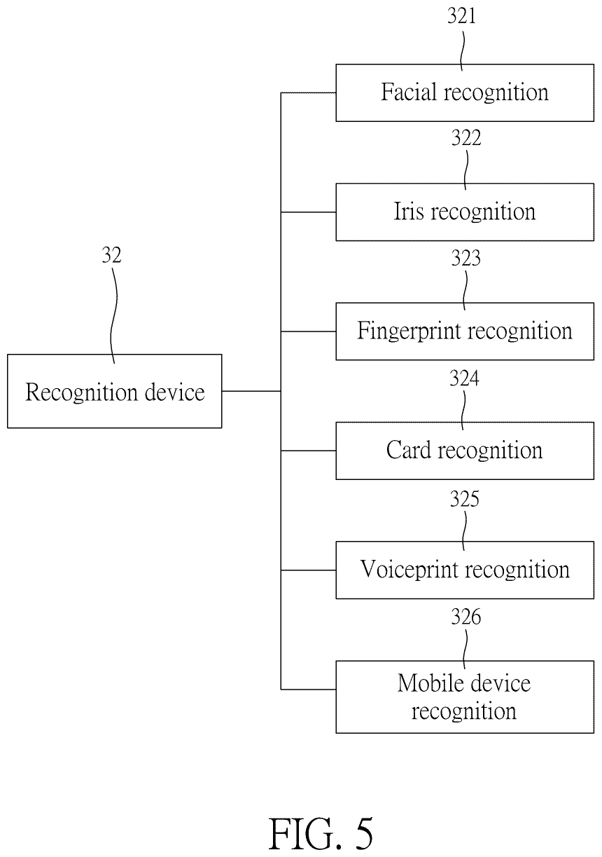

FIG. 5 is a schematic diagram showing a recognition unit of the present invention

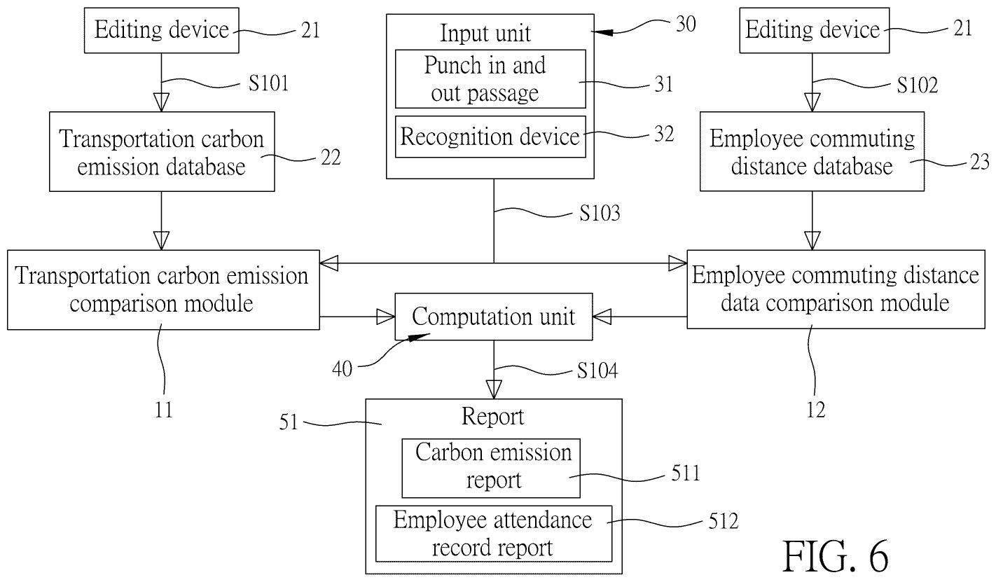

FIG. 6 is a flow chart of a punch in and out system of the present invention;

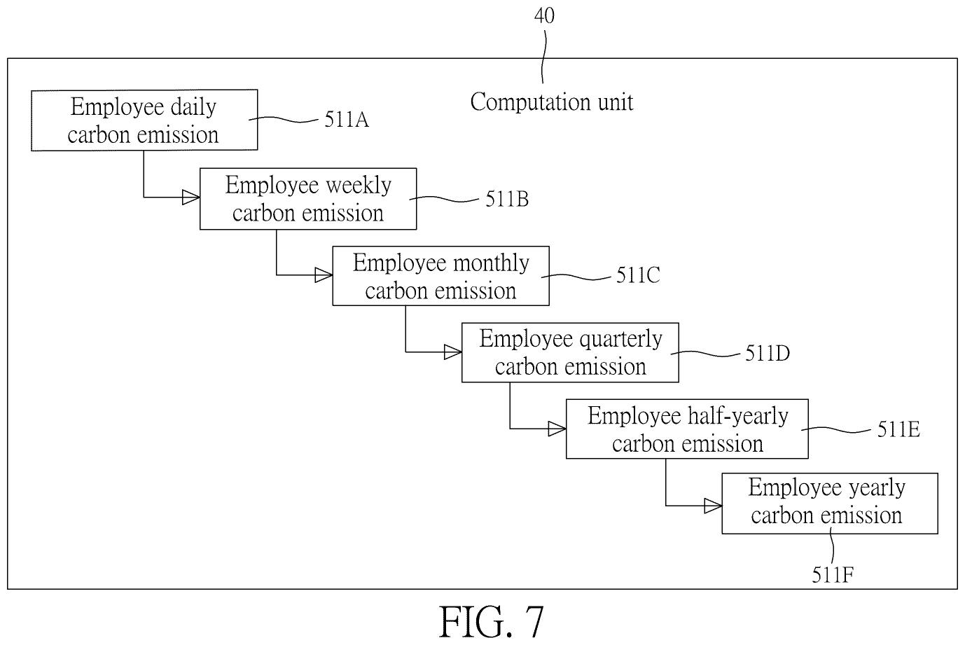

FIG. 7 shows a statistical chart of employee carbon emission values of the present invention;

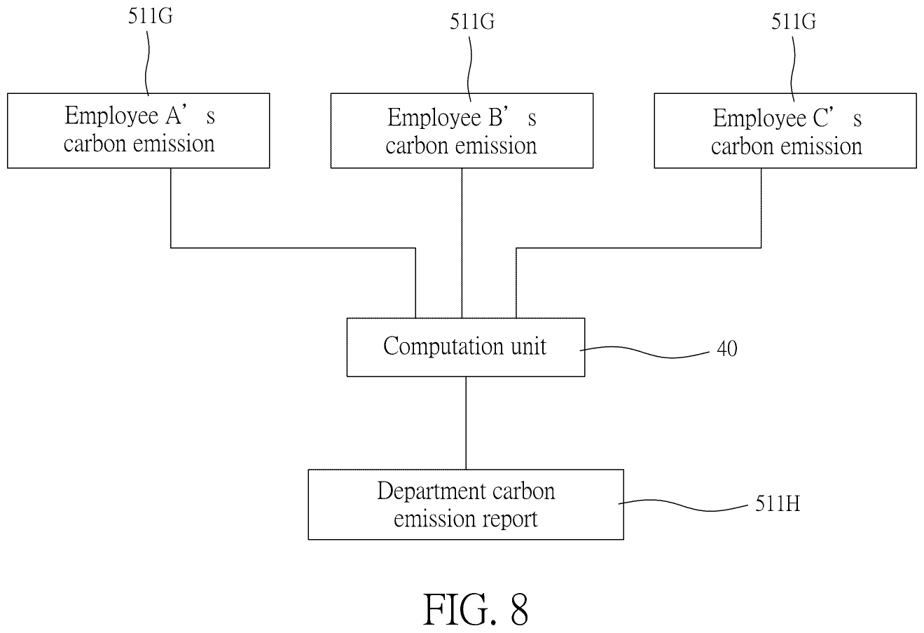

FIG. 8 shows a statistical chart of department carbon emission values of the present invention;

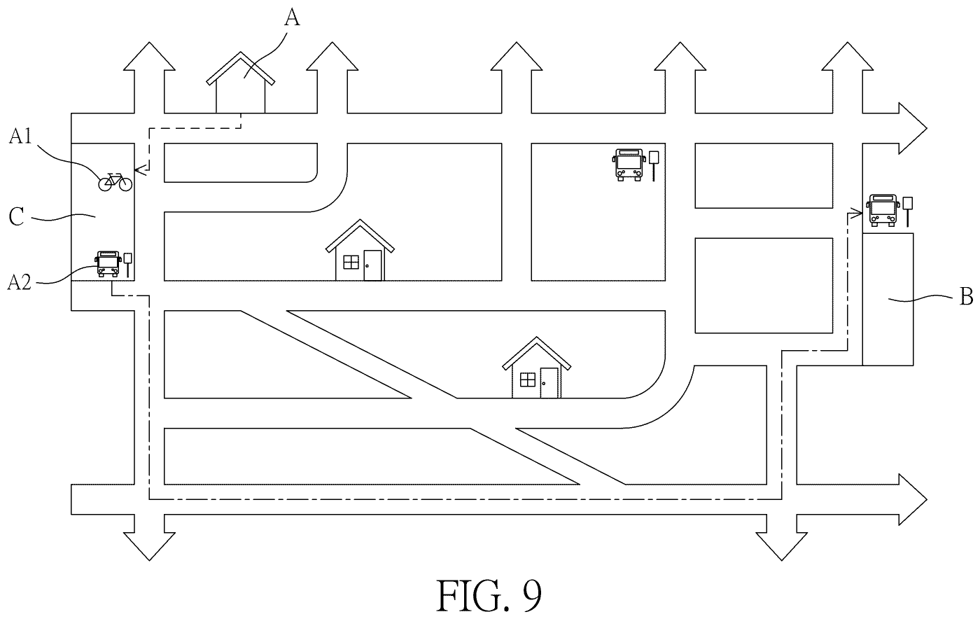

FIG. 9 shows a commuting route map of the present invention; and

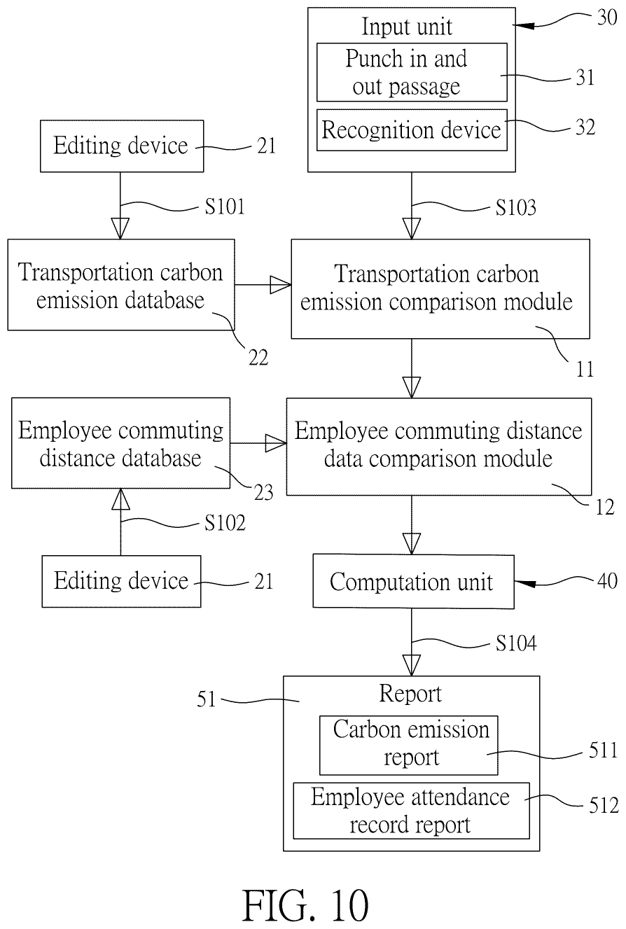

FIG. 10 is a flow chart of a punch in and out system in accordance with another embodiment of the present invention.

### DESCRIPTION OF THE EMBODIMENTS

With reference to FIGS. 2 to 5 for a punch in and out system with a function of automatically measuring carbon footprint from employee commutes in accordance with the present disclosure, the punch in and out system includes a comparison unit 10, a cloud database 20, an input unit 30, a computation unit 40 and an output unit 50.

The comparison unit 10 includes a transportation carbon emission comparison module 11 and an employee commuting distance data comparison module 12.

The cloud database 20 is connected to the comparison unit 10 via a network, and provided with an editing device 21 for editing and storing a transportation carbon emission database 22 and an employee commuting distance database 23, and the transportation carbon emission database 22 stores various transportation carbon emission coefficients (per man-kilometer) and is connected to the transportation carbon emission comparison module 11. The editing device 21 may edit and save the transportation carbon emission database 22 when the transportation carbon emission coefficient (per man-kilometer) is added or revised, and the carbon emission data of various kinds of transportation, taking the “Guidelines for National Greenhouse Gas Inventories” promulgated by Ministry of Environment, Republic of China and carbon emission coefficient for example, (the emission coefficient data of each vehicle will be dynamically updated over time and with technological advancement) include: the emission coefficient is 0.173 kg CO₂ per man-kilometer for cars, 0.088 kg CO₂ per man-kilometer for gas-electric hybrid vehicles, 0.078 kg CO₂ per man-kilometer for electric vehicles, 0.046 kg CO₂ per man-kilometer for traditional motorcycle, 0.025 kg CO₂ per man-kilometer for electric motorcycles, 0.04 kg CO₂ per man-kilometer for buses, 0.04 kg CO₂ per man-kilometer for mass rapid transit, 0.04 kg CO₂ per man-kilometer for high-speed rail, 0.06 kg CO₂ per man-kilometer for trains, 0 kg CO₂ per man-kilometer for bicycles, and 0 kg CO₂ per man-kilometer for walking. The employee commuting distance database 23 stores each of the employee commuting distance data in an enterprise and is connected to the employee commuting distance data comparison module 12, the commuting distance can be estimated through Google map, and the employee commuting distance database 23 can be edited or revised and then saved by the editing device 21 when new employees fill in their mailing address, or deleted from the database by the editing device 21 when employees retire or resign.

The input unit 30 is connected to the comparison unit 10, the input unit 30 includes at least one punch in and out passage 31 and a plurality of recognition devices 32, the at least one punch in and out passage 31 is provided for employees to enter the company for work or leave the company after work, the at least one punch in and out passage 31 can be a single punch in and out passage 31 or a plurality of punch in and out passages 31, the punch in and out passages 31 include a motor vehicle passages 311, gas-electric hybrid vehicle passages 312, electric vehicle passages 313, traditional motorcycle passages 314, electric motorcycle passages 315, high speed rail passages 316, train passages 317, mass rapid transit passages 318, bus passages 319, bicycle passages 31A, pedestrian passages 31B and comprehensive passages 31C (for two or more means of transportation) etc., the plurality of recognition devices 32 is installed to the at least one punch in and out passage 31 and provided for employees to perform recognition by the corresponding recognition device 32 selected according to the commuting transportation and to obtain the information of employee commuting transportation and employee commuting distance. When the at least one punch in and out passage 31 is a single punch in and out passage 31, the single punch in and out passage 31 is provided with a plurality of recognition devices 32; when the at least one punch in and out passages 31 is a multiple of punch in and out passages 31, the plurality of punch in and out passages 31 is provided with at least one recognition device 32, and the recognition device 32 can be a device of facial recognition 321, iris recognition 322, fingerprint recognition 323, card recognition 324, voiceprint recognition 325 or mobile device recognition 326, etc.

The computation unit 40 is connected to the comparison unit 10 to carry out automated and digital computations according to the comparison results of the transportation carbon emission comparison module 11 and the employee commuting distance data comparison module 12.

The output unit 50 is connected to the computation unit 40 and provided for outputting the computation result of the computation unit 40 to generate a report 51, and the report 51 includes a carbon emission report 511 and an employee attendance record report 512.

With reference to FIG. 6 for the process of the punch in and out system with a function of automatically measuring carbon footprint from employee commutes in accordance with the present disclosure, the process includes the following steps (S101 to S104):
(a) Edit a transportation carbon emission value (Step S101), wherein the editing device 21 edits and saves various transportation carbon emission data to the transportation carbon emission database 22, and the editing device 21 can edit and revise the transportation carbon emission data when adding or revising the transportation carbon emission coefficient.
(b) Edit an employee commuting distance (Step S102), wherein the editing device 21 edits and saves the employee commuting distance data of a company to the employee commuting distance database 23, and the commuting distance can be estimated through Google map when new employees fill in their mailing address or employees change their mailing address, and then the editing device 21 edits or revise and then saves the commuting distance.
(c) Perform a recognition (Step S103), wherein if a single punch in and out passage 31 is set, all employees will enter the company through the single punch in and out passage 31, when employees commute to the company from their correspondence address by different means of transportation, and the employees select the corresponding recognition device 32 for recognition according to their commuting transportation, and if a plurality of punch in and out passages 31 is set, the employees select the corresponding punch in and out passage 31 to enter the company and are recognized by the recognition device 32 installed in the plurality of punch in and out passages 31 to obtain the information of each employee's commuting distance to work, while obtaining the type of commuting transportation for the employee to come to work of the day (It is noteworthy that the type of transportation employees use to go to work every day may be different. For a rainy day, they may switch to driving on their own), while synchronously starting the transportation carbon emission comparison module 11 and employee commuting distance data comparison module 12 to perform comparisons.

Similarly, if the single punch in and out passage 31 is set, the employees leave the company through the single punch in and out passage 31 when they get off from work, and select the corresponding recognition device 32 for recognition according to the commuting transportation that the employees plan to take off from work that day, and if the plurality of punch in and out passages 31 is set, the corresponding punch in and out passage 31 is selected to leave the company, and the employees are recognized by the recognition device 32 installed in the plurality of punch in and out passages 31 to obtain the information of each employee's commuting distance after work, as well as the type of commuting transportation that the employees plan to use after work (It is noteworthy that the type of transportation employees use to take off from work every day may be different from the type of transportation they use to go to work), while synchronously starting the transportation carbon emission comparison module 11 and the employee commuting distance data comparison module 12 for comparisons.
(d) Perform a computation (Step S104), wherein the computation unit 40 can compute the carbon emission from employee commutes and the employee attendance record according to the transportation carbon emission value compared and obtained by the transportation carbon emission comparison module 11 and the employee commuting distance compared and obtained by the employee commuting distance data comparison module 12 through automated and digital computation to generate a report provided for review. The report 51 includes a carbon emission report 511 and an employee attendance record report 512, and the carbon emission report 511 can be computed by the computation unit 40 as shown in FIG. 7 to generate an employee daily carbon emission report 511A, an employee weekly carbon emission report 511B, an employee monthly carbon emission report 511C, an employee quarterly carbon emission report 511D, an employee half-yearly carbon emission report 511E, an employee yearly carbon emission report 511F, etc. and each employee's carbon emission report 511G can be computed by the computation unit 40 as shown in FIG. 8 to generate a department carbon emission report 511H.

Through the employee monthly carbon emission report 511C, employee quarterly carbon emission report 511D, employee half-yearly carbon emission report 511E, employee yearly carbon emission report 511F, etc., the increase or decrease in carbon emissions of each employee can be regularly reviewed, and these reports can also be used to encourage each employee to actively take actions to reduce commuting carbon emissions, and even reward or publicly praise them. Similarly, through the department carbon emission report 511H of different departments, the increase or decrease in carbon emissions between different departments can be regularly reviewed, and these reports can be used to encourage each department to actively participate in commuting carbon reduction actions, and even reward or publicly praise the departments of their good results, so that the company can comprehensively respond to commuting carbon reduction actions.

In FIG. 9, when an employee travels from his place of residence A to a transfer station C (which is a bus station in this embodiment) by a first means of transportation A1 (which is a bicycle in this embodiment), and then from the transfer station C to the company B by a second means of transportation A2 (which is a bus in this embodiment), the employee can enter the company through a comprehensive passage 31C, the employee's daily commuting carbon emissions can be automatically and digitally calculated.

With reference to FIG. 10 for a process of a punch in and out system with a function of automatically measuring carbon footprint from employee commutes in accordance with another embodiment of the present disclosure, the difference between this embodiment and the previous embodiment is that in the recognition step (c), the information of the employee commuting transportation and the commuting distance is obtained, and the transportation carbon emission comparison module 11 and the employee commuting distance data comparison module 12 are started asynchronously for comparison. In other words, the transportation carbon emission comparison module 11 is started for comparison first and then the employee commuting distance data comparison module 12 is started for comparison. However, this disclosure is not limited to such sequence, and the employee commuting distance data comparison module 12 is started for comparison first, and then the transportation carbon emission comparison module 11 is started for comparison.

From the structure of the above embodiments, the present disclosure has the following advantages:

In the punch in and out system with a function of automatically measuring carbon footprint from employee commutes and its process in accordance with the present disclosure, the recognitions can be used for the automatic punch in and out operations and the generation of each employee's attendance record report, improve the company's performance, while improving personnel management efficiency, automatically and digitally calculating each employee's commuting carbon emissions, replacing the traditional annual carbon footprint verification that relies on a manual and tedious collection of data and rough estimates, and improving the efficiency and accuracy of carbon footprint verification to facilitate the management and improvement of carbon emissions from employee commutes.

While the first embodiments of the invention have been set forth for the purpose of disclosure, modifications of the disclosed embodiments of the invention as well as other embodiments thereof may occur to those skilled in the art. The scope of the claims should not be limited by the first embodiments set forth in the examples, but should be given the broadest interpretation consistent with the description as a whole.

What is claimed is:

1. A punch in and out system with a function of automatically measuring carbon footprint from employee commutes, comprising:
a comparison unit, comprising a transportation carbon emission comparison module and an employee commuting distance data comparison module, for obtaining information on an employee commuting transportation and an employee commuting distance;
a cloud database, coupled to the comparison unit, and provided with an editing device. for editing and storing a transportation carbon emission database and an employee commuting distance database, the transportation carbon emission database is coupled to the transportation carbon emission comparison module, and the employee commuting distance database is coupled to the employee commuting distance data comparison module;
an input unit, coupled with the comparison unit, and comprising at least one punch in and out passage and a plurality of recognition devices, the at least one punch in and out passage being provided for an employee to enter into a company for work or leave the company after work, the plurality of recognition devices being installed to the at least one punch in and out passage and provided for the employee to select a corresponding recognition device for recognition according to commuting transportation;
a computation unit, coupled to the comparison unit, for carrying out a computation according to the comparison result of the transportation carbon emission comparison module and the employee commuting distance data comparison module; and
an output unit, coupled to the computation unit, for outputting the computation unit computation result to generate a report.

2. The punch in and out system with a function of automatically measuring carbon footprint from employee commutes according to claim 1, wherein the transportation carbon emission database stores various transportation carbon emission data, the transportation carbon emission database can be edited and stored by the editing device when a transportation carbon emission coefficient (per man-kilometer) is added or revised, the employee commuting distance database stores the employee commuting distance data of each employee in an enterprise, the employee commuting distance database can be edited, revised and then saved by the editing device, when new employees fill in their mailing address, or when employees change their mailing address.

3. The punch in and out system with a function of automatically measuring carbon footprint from employee commutes according to claim 1, wherein the at least one a punch in and out passage comprises a car passage, a gas-electric hybrid vehicle passage, an electric vehicle passage, a traditional motorcycle passage, an electric motorcycle passage, a high speed rail passage, a train passage, a mass rapid transit passage, a bus passage, a bicycle passage, a pedestrian passage and a passage for two or more means of transportation.

4. The punch in and out system with a function of automatically measuring carbon footprint from employee commutes according to claim 1, wherein the recognition device is a device of facial recognition, iris recognition, fingerprint recognition, card recognition, voiceprint recognition or mobile device recognition.

5. The punch in and out system with a function of automatically measuring carbon footprint from employee commutes according to claim 1, wherein the report comprises a carbon emission report and an employee attendance record report.

6. The punch in and out system with a function of automatically measuring carbon footprint from employee commutes according to claim 1, wherein the punch in and out system adopts a process comprising the steps of:
(a) editing a transportation carbon emission value, wherein the editing device edits and saves various transportation carbon emission coefficients (per man-kilometer) to the transportation carbon emission database;
(b) editing an employee commuting distance, wherein the editing device edits and saves the employee commuting distance data to the employee commuting distance database of a company;
(c) performing a recognition step, wherein when an employee arrives at the company, the employee enters into a punch in and out passage and selects a corresponding recognition device for recognition, and the comparison unit obtains the information of the employee commuting transportation and employee commuting distance and simultaneously starts the transportation carbon emission comparison module and the employee commuting distance data comparison module to perform a comparison; and
(d) performing a computation step, wherein a carbon emission report and an employee attendance record report are generated and provided for review automatically based on the compared transportation carbon emission value and the compared employee commuting distance.

7. The punch in and out system with a function of automatically measuring carbon footprint from employee commutes according to claim 6, wherein the carbon emission report in the computation step (d) comprises an employee daily carbon emission report, an employee weekly carbon emission report, an employee monthly carbon emission report, an employee quarterly carbon emission report, an employee half-yearly carbon emission report and an employee yearly carbon emission report, which are generated by the computation unit.

8. The punch in and out system with a function of automatically measuring carbon footprint from employee commutes according to claim 6, wherein in the computation step (d), the computation unit computes each employee carbon emission report of a department to generate a department carbon emission report.

9. The punch in and out system with a function of automatically measuring carbon footprint from employee commutes according to claim 1, wherein the punch in and out system adopts a process comprising the steps of:
(a) editing a transportation carbon emission value, wherein the editing device edits and saves various transportation carbon emission coefficients (per man-kilometer) to the transportation carbon emission database;
(b) editing an employee commuting distance, wherein the editing device edits and saves the employee commuting distance data to the employee commuting distance database of a company;
(c) performing a recognition step, wherein when an employee arrives at the company, the employee enters into a punch in and out passage and selects a corresponding recognition device for recognition, and the comparison unit obtains the information of the employee commuting transportation and employee commuting distance and asynchronously starts the transportation carbon emission comparison module and the employee commuting distance data comparison module to perform a comparison; and
(d) performing a computation step, wherein a carbon emission report and an employee attendance record report are generated and provided for review automatically based on the compared transportation carbon emission value and the compared employee commuting distance.

10. The punch in and out system with a function of automatically measuring carbon footprint from employee commutes according to claim 9, wherein in the recognition step (c), the transportation carbon emission comparison module is started to perform a comparison first, and then the employee commuting distance data comparison module is started to perform a comparison, or the employee commuting distance data comparison module is started to perform a comparison first, and then the transportation carbon emission comparison module is started to perform a comparison.
